(19) United States
(12) Patent Application Publication
(10) Pub. No.: US 2016/0220339 A1
(43) Pub. Date: Aug. 4, 2016

(54) ORAL CARE DEVICE

(71) Applicant: Kun Zhao, Quincy, MA (US)

(72) Inventor: Kun Zhao, Quincy, MA (US)

(21) Appl. No.: 15/012,128

(22) Filed: Feb. 1, 2016

Related U.S. Application Data
(60) Provisional application No. 62/110,573, filed on Feb. 1, 2015.

(51) Int. Cl. A61C 17/02; A61H 9/00

(52) U.S. Cl. CPC A61C 17/0214; A61H 9/00

(57) ABSTRACT

An oral care device including an elongated handle having a hollow interior extending through the length of the handle is provided. The device includes intraoral tip defining a fluid passage through a length thereof is coupled to the handle, the intraoral tip including a head defining a plurality of outlet ports. The handle defining at least one air inlet including a fluid path extending through a sidewall of the handle and in fluid communication with the hollow interior of the handle, the air inlet configured to allow ambient air to mix with fluid passing through the handle for aerating the fluid. A water line is connectable between the handle and a water source. The oral care device for cleaning and massaging a user's teeth and oral mucosa is useable in a shower stall.

### CROSS-REFERENCE TO RELATED APPLICATIONS

This application claims the benefit under 35 U.S.C. §119(e) of U.S. Provisional Application No. 62/110,573 filed Feb. 1, 2015, the entire disclosure of which is hereby incorporated by reference.

### FIELD OF THE INVENTION

The present disclosure relates generally to an oral care device in the field of home health care and preventive oral health care apparatus. More particularly, the disclosure relates to a full arch ultrasonic cleaner apparatus including an applicator defining a cavity for receiving a cleaning agent and a plurality of ultrasonic transducers mounted to the applicator

### BACKGROUND OF THE INVENTION

The statements in this section merely provide background information related to the present disclosure and may not constitute prior art.

Gingivitis and periodontitis are the most common diseases of mankind. This is a group of diseases commonly referred as periodontal disease. Periodontal disease is caused by bacteria in dental plaque and calculus. Thus, removal of plaque and calculus is not only a preventive measure, but also the essential part of the treatment in periodontal disease. Carefully performed home care through brushing and flossing of one's teeth can well control the formation of plaque and calculus, and also remove soft plaque.

Traditionally, home oral care includes brushing teeth and flossing regularly. Much effort has been made to improve toothbrushes, toothpaste and dental floss. Electric toothbrushes, ultrasonic electric toothbrushes and mouth irrigators have been introduced and/or improved over the last decade.

Brushing teeth is a healthy habit that is relatively easy to make and therefore an established common practice in many households. However, brushing teeth alone is not sufficient to combat plaque and calculus formation. Rather flossing is necessary to clean the areas between the teeth (interproximal area). Unfortunately, regular flossing has been proven to be much more difficult to establish as commonplace oral care for a majority of the population.

It is an object of the present teachings to provide an oral care device that improves upon and overcomes many of the shortcomings of prior art tools and methods.

### SUMMARY OF THE INVENTION

This section includes a general summary of the disclosure and does not provide a comprehensive description or include full scope or all the features of the subject matter disclosed.

According to one aspect, the present teachings provide an oral care device including an elongated handle having a hollow interior extending through the length of the handle, and an intraoral tip having first and second opposing ends and defining a channel through a length thereof for carrying a fluid, the first end coupled to the handle, the intraoral tip including a head defining a plurality a outlet ports, the outlet ports fluidly coupled to the hollow interior of the handle via the channel. The handle defining at least one air inlet including a fluid path extending through a sidewall of the handle and in fluid communication with the hollow interior of the handle, the air inlet configured to allow ambient air to mix with fluid passing through the handle for aerating the fluid. A water line is connected to the handle at one end and configured for attachment to a water source at an opposing end. A valve is coupled to the handle for controlling the flow of fluid through the hollow interior of the handle. The oral care device for cleaning and massaging a user's teeth and oral mucosa by placing the intraoral tip inside the oral cavity and adjacent the user's teeth and allowing a fluid flow, such as tap water, passing through the intraoral tip to clean and massage the teeth and oral mucosa.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description, the appended claims and the following drawings. The drawings are for illustrative purposes only and are not intended to limit the scope of the present disclosure.

FIG. 1 is a perspective view of one embodiment of an oral care device according to the present invention.

FIG. 2A is a perspective view of one embodiment of an intraoral tip of the oral care device of FIG. 1.

FIG. 2B is a perspective view of another embodiment of an intraoral tip connectable to the oral care device of FIG. 1.

FIG. 3 is partial cross-sectional side view of the oral care device of FIG. 1

FIG. 4 is a perspective view of a water line and coupler for a shower pipe in accordance with the present invention.

### DETAILED DESCRIPTION OF EMBODIMENTS OF THE INVENTION

Detailed illustrative descriptions of example embodiments are disclosed herein. However, specific structural and functional details disclosed herein are merely representative for purposes of describing example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected,” “coupled,” “mated,” “attached,” or “fixed” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between”versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the language explicitly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

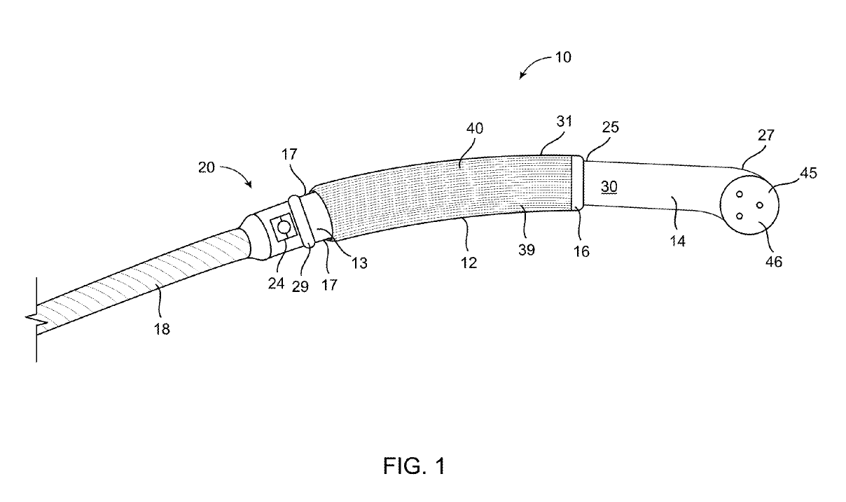

FIGS. 1-3 illustrate an example embodiment oral care device 10 according to the present invention. The oral care device 10 includes a handle 12 and an intraoral tip 14 removably coupled to the handle via a collar 16. A water line 18 is connected to a water source 56 at one end and to an inlet end 20 of the handle 12 at the other end. The handle 12 includes a valve 24 manually operable to control a flow of water through the handle 12 and intraoral tip 14. In one embodiment, the valve 24 is operable for variably controlling a volume of water passing through the handle in one of a fully open position, a closed position, and a partially open position wherein the valve is positioned between the open position and the closed position. The partially open position includes a range of positions wherein the flow of water can be regulated depending on user need or preference.

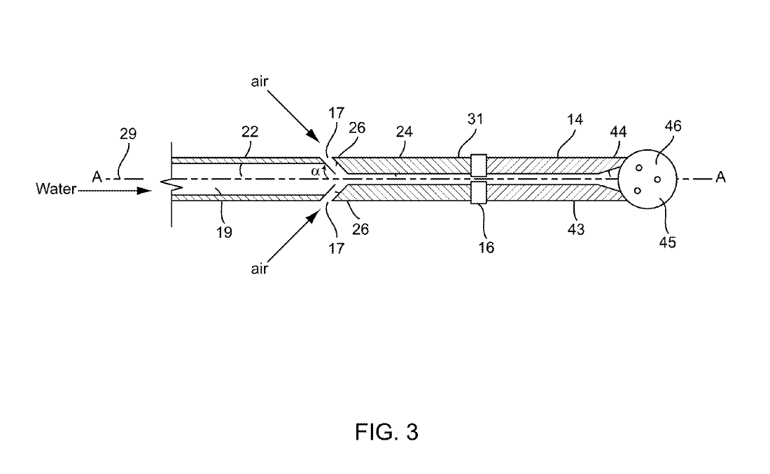

As shown in FIG. 3, the handle 12 defines a hollow interior 19 through a length thereof for carrying water from a water source through the handle to the intraoral tip 14. The hollow interior 19 is defined in part by a first bore 22 extending from the inlet end 20 of the handle to a midpoint of the handle wherein the first bore converges and connects to a second bore 24 which extends from the first bore through to the outlet end 31 of handle 12. The second bore 24 having a diameter smaller than the diameter of the first bore 22. At least one air inlet 17 defines an opening through a sidewall 13 of the handle 12 near the midpoint of the handle 12. A pathway 26 connects the air inlet 17 to the first and second bores 22, 24 respectively, near the juncture thereof. The air inlet 17 allows ambient air to enter a stream of water 29 passing through the handle 12 for aerating the water prior to delivery of the water through the intraoral tip 14 and to the oral cavity of a user. In one embodiment the air inlet 17 is positioned at the juncture of the first bore 22 and the second bore 24 so that a Venturi effect caused by the water passing through the constricted section at the juncture of the first and second bores 22, 24 facilitates inflow of air through the air inlet 17 for aerating the water passing through the handle 12. In one embodiment the pathway 26 is disposed at an angle ct relative to a longitudinal axis A-A extending through the handle 12 and intraoral tip 14. Preferably, the angle α is in a range of about 40 degrees to about 60 degrees. In one embodiment of the handle 12, the angle α is about 45 degrees.

Referring to FIG. 1, in one embodiment the handle 12 includes a cover for closing the air inlet, such as a sleeve 29 that is slideably coupled to the handle 12 for movement between a first position wherein the air inlet 17 is open and a second position wherein the air inlet 17 is closed. In the first position the sleeve is moved lengthwise along the handle 12 to a position wherein the air inlet 17 is fully exposed so that ambient air is free to enter the air inlet 17. In the second position the sleeve 29 is moved to block and/or seal the air inlet 17 thereby preventing air from entering the air inlet 17. The sleeve 29 is also positionable between the first and second positions wherein the air inlet 17 is partially open so that a user can regulate a volume of air entering the air inlet and control the aeration of the water passing through the handle 12.

As shown in the FIG. 1 embodiment, a sidewall 39 of the handle 12 defines a plurality of longitudinal grooves 40 extending along a length of the handle 12. The grooves 40 provide a grip area of the handle for a user to grasp for securely holding the handle 12.

The intraoral tip 14 includes an inlet end 25 coupled to an outlet end 31 of the handle 12 via a collar 16. In one embodiment the intraoral tip 14 defines a flange 28 near the inlet end 25 of the intraoral tip 14, the flange 28 extending outwardly from a sidewall 30 of the intraoral tip for engaging the collar 16. In one embodiment the collar 16 is threadably coupled to the outlet end 31 of the handle 12 for connecting the intraoral tip 14 to the handle. The threaded collar 16 provides for easy removing and replacing one intraoral tip 14 with another intraoral tip for use by different users of for use of an intraoral tip with a different head configuration. In one embodiment the intraoral tip 14 is color coded so that each user of a household or user of a shower can use his/her own intraoral tip.

The intraoral tip 14 defines an axial bore 43 extending through a length of the intraoral tip. The bore 43 is in fluid communication with the second bore 24 of the handle 12 and is configured to receive water exiting the handle and carry the water through the intraoral tip 14 towards the outlet end 27 thereof. As shown in FIG. 3, the bore 43 opens to a wider divergent area 44 near a head 45. The intraoral tip 14 includes the head 45 formed at an outlet end 27 thereof. The head 45 defines a generally smooth flat face 46 for engaging the teeth, gums and oral mucous of a user of the oral care device 10. The face 46 defines a plurality of openings 48 extending through the face 46 which are in fluid communication with the divergent area 44 of the bore 43 and configured as exit ports for the water passing through the intraoral tip 14. The head 45 and openings 48 therethrough are configured to be used inside the oral cavity of a user of the oral care device 10 such that the water exiting the openings 48 will project outwardly from the head 45 for contact the teeth and oral mucous of the user for cleaning and/or massaging the teeth and tissue of the user.

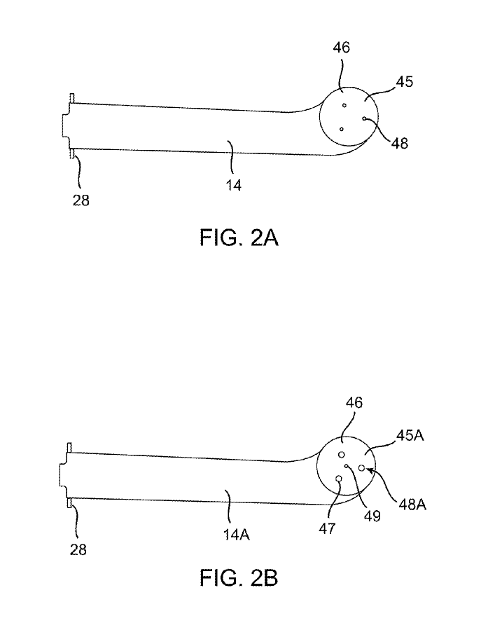

As shown in the FIG. 2A, in one embodiment the intraoral tip 14 has three openings 48 on the head 45, however, more or less openings 48 can be provided. Further, in various embodiments of the head 45, the openings 48 are of different shapes including circular, semi-circular, rectangular, oval, etc. Further, the shape of the head 45 is round in the illustrated embodiment, however in other embodiments the head may be rectangular, oval, etc. Thus, the circular openings 48 and round head 45 shown in the FIG. 1 embodiment should not be considered limiting as to the features of the disclosed invention.

Referring to FIG. 2B, another embodiment of an intraoral tip 14A is connectable to the handle 12 via a flange 28 as discussed above. The intraoral tip 14A has a head 45A defining a flat face 46 as set forth above with respect to the intraoral tip 14. The head 45A defines a plurality of openings collectively 48A which include a circular pattern of three outer openings 47 surrounding a central opening 49. The openings 48A extend through the face 46 and are in fluid communication with the divergent area 44 of the bore 43 and configured as exit ports for the water passing through the intraoral tip 14A. The head 45A and openings 48A therethrough are configured to be used inside the oral cavity of a user of the oral care device 10 such that the water exiting the openings 48 will project outwardly from the head 45A for contact the teeth and oral mucous of the user for cleaning and/or massaging the teeth and tissue of the user.

As shown in FIG. 2B, the central opening 49 is smaller in diameter than the surrounding outer openings 47 and configured to provide a smaller yet more forceful water jet flowing outwardly therefrom compared to an outflow of water from the surrounding larger diameter outer openings 47. The water exiting the central opening 49 is configured to be used to clean the inter-proximal surfaces (between the teeth) similar to flossing. Whereas, the larger outer openings 47 surrounding the central opening 49 are configured to provide a water jet to clean and massage the surfaces of the teeth, the oral mucous and gingival tissue of the user.

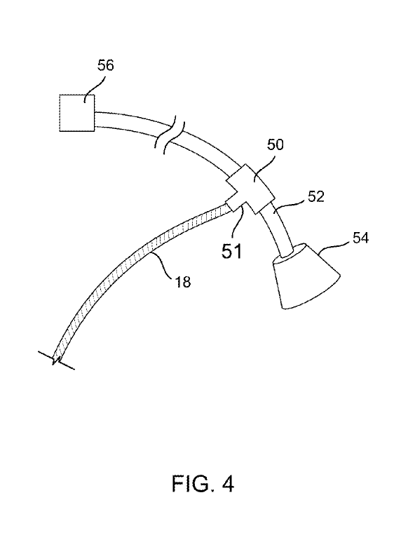

Referring to FIG. 4, in one embodiment the oral care device 10 includes a tee 50 coupled to a water pipe 52 for a shower head 54. In the FIG. 4 embodiment, the water line 18 is coupled to the outlet 51 of the tee so that the water line 18 and the oral care device 10 can be used while the shower head 54 is also in use. The valve 24 can be used to control the water flow through the oral care device 10 in this configuration. Alternatively, the tee can include a diverter valve (not shown) wherein operation of the diverter valve allows one or the other of the shower head 54 or the oral care device 10 to be used. Thus, in a preferred embodiment the oral care device 10 is configured to connect to a water pipe 52 supplying water to a shower head 54 within a shower stall or a tub having a shower (not shown) while the shower is operating. In another embodiment a diverter valve may be used so that the oral care device 10 can be used alternatively with a shower head 54.

As shown in FIG. 4, the oral care device 10 of the present invention is configured to operate coupled using tap water and the pressure supplied thereby. Thus, a water reservoir or pump are not required for operation of the disclosed oral care device.

Example embodiments and methods thus being described, it will be appreciated by one skilled in the art that example embodiments and example methods may be varied through routine experimentation and without further inventive activity. Variations are not to be regarded as departure from the spirit and scope of the exemplary embodiments, and all such modifications as would be obvious to one skilled in the art are intended to be included within the scope of the following claims.

What is claimed is:

1. An oral care device comprising:
an elongated handle having a hollow interior extending through the length of the handle;
an intraoral tip having first and second opposing ends and defining a passage through a length thereof for carrying a fluid, the first end coupled to the handle, a head defining a plurality of outlet ports forming the second end of the intraoral tip, the outlet ports fluidly coupled to the hollow interior of the handle via the passage;
the handle defining at least one air inlet including a fluid path extending through a sidewall of the handle and in fluid communication with the hollow interior of the handle, the air inlet configured to allow ambient air to mix with fluid passing through the handle for aerating the fluid;
a water line connected to the handle at one end and configured for attachment to a water source at the other end thereof;
a valve coupled to the handle for controlling the flow of fluid through the hollow interior of the handle, the valve being operable in one of an open position, a closed position, and a partially open position for variably controlling a volume of fluid flowing through the handle and the intraoral tip; and wherein
the oral care device for cleaning and massaging a user's teeth and oral mucosa by placing the intraoral tip inside the oral cavity and adjacent the user's teeth and allowing a fluid flow passing through the intraoral tip to clean and massage the teeth and oral mucosa.

2. The oral care device of claim 1 wherein the fluid path is disposed at an angle relative to an axis of the handle in a range of about 40 degrees to about 60 degrees.

3. The oral care device of claim 1 wherein the fluid path is disposed at an angle of about 45 degrees relative to an axis of the handle.

4. The oral care device of claim 1 further comprising a cover coupled to the handle for movement relative to the handle, the cover configured to close the air inlet in one position and open the air inlet in a second position.

5. The oral care device of claim 4 wherein the cover comprises a sleeve slideably coupled to the handle.

6. The oral care device of claim 4 wherein the cover is movable to a third position wherein the air inlet is partially open.

7. The oral care device of claim 1 further comprising a tee for coupling the water line to a pipe for a shower head.

8. The oral care device of claim 1 wherein the intraoral tip is removable from the handle.

9. The oral care device of claim 1 wherein the intraoral tip is removable from the handle.

10. The oral care device of claim 1 wherein the intraoral tip includes a plurality of intraoral tips, each intraoral tip being color coded for use by a different user.

11. The oral care device of claim 1 wherein the hollow interior of the intraoral tip is defined by first and second bores extending throughout a length thereof, the first bore extending from an inlet end of the handle to a midpoint of the handle, and a second bore connected to the first bore and extending from the midpoint to the head of the intraoral tip.

12. The oral care device of claim 11 wherein the first bore defines a diameter larger than a diameter of the second bore.

13. The oral care device of claim 11 wherein the passage in communication with the air inlet is disposed at the midpoint of the handle and adjacent the convergence of the first bore through the handle.

14. The oral care device of claim 1 wherein the oral care device and the water line thereof are configured for use with tap water and the pressure provided thereby.

15. The oral care device of claim 1 wherein the plurality of outlet ports include a central opening surrounded by a plurality of outer openings disposed in a circle surrounding the central opening.

16. The oral care device according to claim 15 wherein the central opening has a diameter smaller than a diameter of each of the outer openings.
